(19) United States
(12) Patent Application Publication
(10) Pub. No.: US 2009/0151686 A1
(43) Pub. Date: Jun. 18, 2009

(54) SUPERCHARGED INTERNAL COMBUSTION ENGINE

(76) Inventor: Bill NGUYEN, CARSON, CA (US)

Correspondence Address: SELDON & SCILLIERI, 12121 WILSHIRE BLVD., SUITE 1300, LOS ANGELES, CA, 90025-1166, US

(21) Appl. No.: 12/276,255

(22) Filed: Nov. 21, 2008

Related U.S. Application Data
(60) Provisional application No. 61/007,208, filed on Dec. 12, 2007.

(51) Int. Cl. F02F 11/00

(52) U.S. Cl. 123/193.2; 277/591

(57) ABSTRACT

An internal combustion engine includes at least one piston that compresses air in the lower cylinder chamber as it transitions from top dead center to bottom dead center during the power stroke. The air in the lower cylinder chamber is compressed between the downward-moving cylinder and a structure that substantially seals the lower chamber from the crankcase chamber so that compression takes place in a chamber smaller than the crankcase chamber.

### BACKGROUND OF THE DISCLOSURE

This invention relates to supercharged internal combustion engines, typically of the two stroke or four stroke type. Supercharging is typically accomplished by compressing the air to be fed into the engine's combustion chamber prior to its entry into the combustion chamber. One approach has been to utilize the engine's crankcase as an air (or air/fuel mixture) compression chamber from which the compressed air (or air/fuel mixture) is directed into the combustion chamber during the intake portion of the engine's cycle.

### DESCRIPTION OF RELATED ART

Examples of internal combustion engines utilizing the engine's crankcase as an air (or air/fuel mixture) compression chamber from which the compressed air (or air/fuel mixture) is directed into the combustion chamber during the intake portion of the engine's cycle can be found in U.S. Pat. Nos. 4,461,251 and 6,561,159 (the contents of which are hereby incorporated by reference).

### SUMMARY OF THE DISCLOSURE

An internal combustion engine is described wherein air (or air/fuel mixture) is compressed, prior to intake into the combustion chamber, in a compression chamber that is smaller than the engine's crankcase by the piston as it moves towards bottom dead center. An engine constructed in accordance with the invention can have one or more pistons, and be of the two stroke or four stroke type. Moreover, an engine constructed in court in accordance with the invention is not limited to the use of any particular fuel.

These and further details will be apparent to those of ordinary skill in the art from reading the following detailed description, of which the drawings form a part.

### BRIEF DESCRIPTION OF THE DRAWINGS

FIG. 1 is a sectional view in schematic of a two stroke engine showing the piston in the compression stroke moving upward and approaching top dead center;

FIG. 2 is a sectional view of the two stroke engine of FIG. 1 in schematic showing the piston at the beginning at its power stroke moving downward from top dead center;

FIG. 3 is a sectional view of the two stroke engine of FIG. 1 in schematic showing the piston beginning its exhaust stroke near bottom dead center;

FIG. 4 is a sectional view in schematic of an alternative embodiment of the engine of FIG. 1 showing the piston in the compression stroke moving upward and approaching top dead center;

FIG. 5 is a sectional view of the two stroke engine of FIG. 4 in schematic showing the piston at the beginning at its power stroke moving downward from top dead center;

FIG. 6 is a sectional view of the two stroke engine of FIG. 4 in schematic showing the piston beginning its exhaust stroke near bottom dead center;

FIG. 7 is a sectional view in schematic of a third embodiment of the engine of FIG. 1 showing the piston in the compression stroke moving upward and approaching top dead center;

FIG. 8 is a sectional view of the two stroke engine of FIG. 7 in schematic showing the piston at the beginning at its power stroke moving downward from top dead center;

FIG. 9 is a sectional view of the two stroke engine of FIG. 7 in schematic showing the piston beginning its exhaust stroke near bottom dead center;

FIG. 10 is a perspective view of the seal plate 1A shown in FIG. 1;

FIG. 11 is a right side view of the seal plate illustrated in FIG. 10 taken along line 11-11 thereof, FIG. 12 is a detail drawing of the pivot joint associated with the seal plate of FIG. 10;

FIGS. 13-15 are respective sectional views in schematic of a fourth embodiment of an internal combustion engine illustrating the operation of the engine; and

FIG. 16 is a detailed fragmentary sectional view in schematic showing oil conducting channels that can be utilized in the illustrated engines.

### DETAILED DESCRIPTION

In the following detailed description of the embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

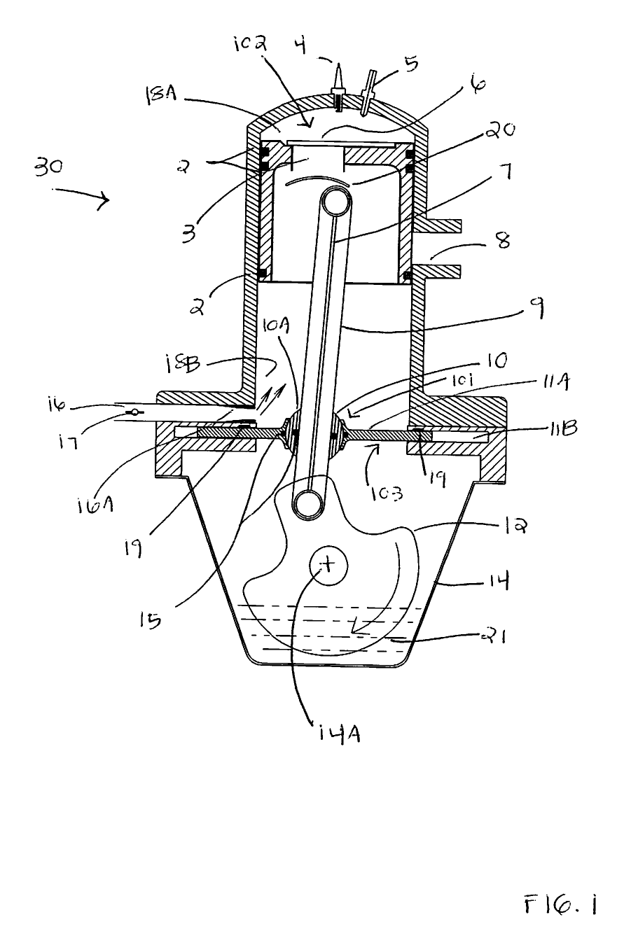

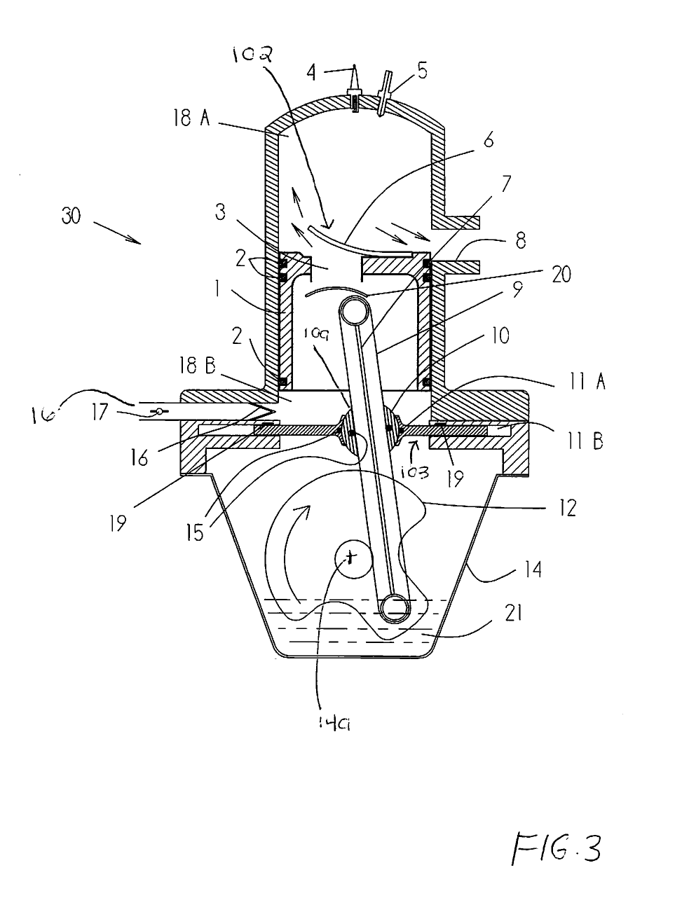

Referring initially to FIG. 1, a sectional view in schematic is presented showing a two cycle engine constructed in accordance with the invention. The engine 30 comprises a body having a cylinder bore 18 extending from a top end region 102 towards a bottom end region 101. A piston 1 is mounted within the cylinder bore 18 for reciprocating movement between top and bottom positions respectively illustrated in FIGS. 1 and 3. The piston 1 defines a lower cylinder chamber 18b between the piston and the bottom of the cylinder bore, and an upper cylinder chamber 18a between the top of the cylinder bore and the piston. It may be noted that the terms “top” and “bottom” are relative; the direction of reciprocating movement may be horizontal or at some angle to the vertical. The terms “top” and “bottom” will be recognized by those of ordinary skill in the art as being used in the same manner as the terms “top dead center” and “bottom dead center” with respect to piston travel regardless of whether the reciprocating piston movement is vertical, horizontal or at some other angle.

The piston 1 sealingly engages the inner wall of the cylinder through piston rings 2. The piston rings 2 substantially seal the upper cylinder chamber 18A from the lower cylinder chamber 18b as the piston reciprocates.

A crankcase 14 is located adjacent the bottom end region of the cylinder bore, and defines a chamber that contains a lubricating fluid 21 such as oil. A crankshaft 12 is mounted for rotation within the crankshaft chamber. A connecting rod 9 is coupled at its upper end to the piston 1 and at its lower end to the crankshaft so as to transmit motion therebetween. Specifically, as known in the art, the rotational movement of the crankshaft results in reciprocating movement of the piston.

An oil line 7 conducts lubricating oil from the crankcase to the coupling mechanism (not shown) that couples the connecting rod 9 to the piston 1. The illustrated oil line 7 extends within and along the connecting rod 9, but other configurations are well known in the art and may be employed.

A lower cylinder chamber seal 103 is positioned to substantially seal the lower cylinder chamber 18B from the chamber of the crankcase 14. The seal is configured to permit the passage of the connecting rod 9 from the crankcase chamber to the piston and to accommodate the reciprocating movement of the connecting rod; in the illustrated embodiment, the seal 103 is specifically configured to accommodate the movement of the connecting rod in a direction generally perpendicular to the direction of reciprocating piston movement as well as in the direction of reciprocating piston movement. Accordingly, the seal 103 preferably includes a seal plate 11A which provides a physical barrier between the crankcase chamber and the lower cylinder chamber. The seal plate 11A has a generally central through-hole 10a through which the connecting rod 9 passes. A seal about the through hole, such as O-ring 15, enables the connecting rod to move reciprocally though the seal plate while maintaining a substantial seal between the crankcase chamber and lower cylinder chamber.

The through hole 10a is preferably formed in a pivot joint 10 that pivots with respect to the remainder of the seal plate 11A in a ball-and-socket manner to accommodate the movement of the reciprocating connecting rod along at least one axis not parallel to the direction of piston movement.

To further accommodate the connecting rod's movement during its reciprocating movement, the seal plate 11A is permitted to slide generally transversely to the direction of piston movement. Accordingly, an inner wall portion of the lower cylinder chamber adjacent said seal member is provided with a slideway 11B extending generally transversely to the direction of piston movement and is sized to accommodate transverse displacement of the seal plate induced by the reciprocating movement of the connecting rod. The seal plate sealingly engages the slideway 11B through oil seals 19 to substantially prevent leakage between the lower cylinder chamber and the crankcase cavity.

Referring initially to FIG. 1, the operation of an engine constructed in accordance with the invention is now described. FIG. 1 illustrates the piston 1 just before top dead center. In a two-cycle embodiment, fuel has been introduced into the upper cylinder chamber 18A via fuel injector 5, and the compressed air therein and fuel have been ignited by a spark plug 4. It may be noted that the means for igniting the compressed air is not necessarily a spark plug. In some internal combustion engines, such as diesel engines, there is no spark plug; instead, ignition takes place when the fuel is timely injected into the hot compressed air in the upper cylinder chamber because the air is compressed sufficiently by the rising piston to increase its temperature to (or beyond) the ignition temperature of the fuel.

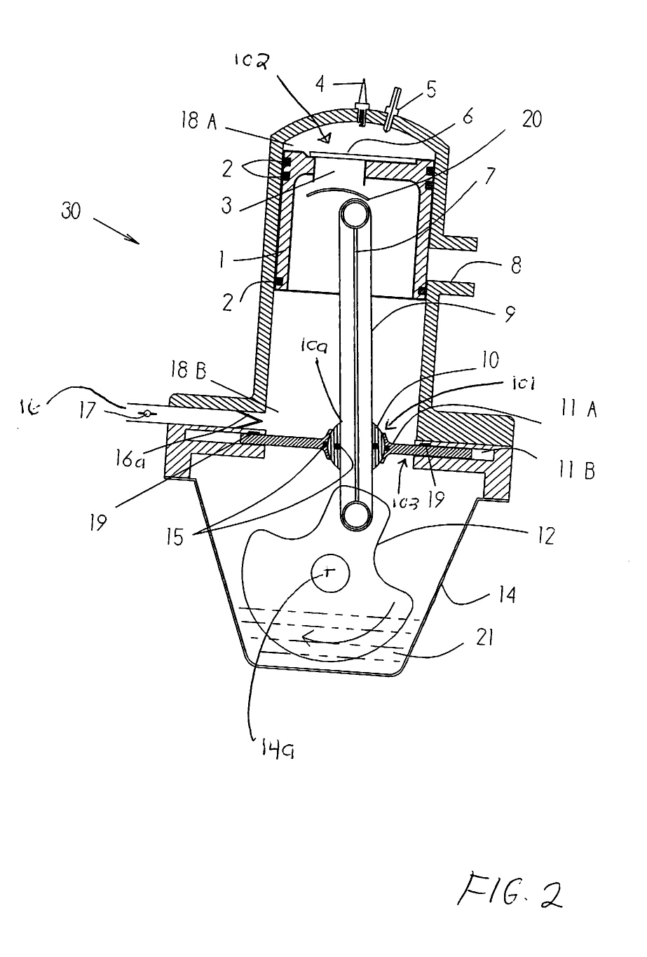

The combusting gasses are substantially sealed from the exhaust port 8 by piston rings 2 and the piston. As the combusting fuel/air mixture in the upper cylinder chamber 18A begins to expand, it accordingly forces the piston downward from top dead center, as illustrated in FIG. 2, compressing the air that has been previously introduced into the lower cylinder chamber 18B via a one-way valve 16a in inlet passageway 16. The one way valve 16a has bow been closed to prevent the air in the lower cylinder chamber 18B from escaping through the inlet 17 as it is compressed.

The piston movement causes rotational movement of the crankshaft 12. The connecting rod 9 couples the piston 1 to the crankshaft 12, which rotates about axis 14a in response to the piston's reciprocal motion, much like the pedals on a bicycle responding to the reciprocating motion of the rider's knees. The connecting rod is accordingly coupled to the piston for pivoting movement, and to the crankshaft for rotating movement as is known in the art. In FIG. 1, the connecting rod/crankshaft coupling is accordingly illustrated as being at an approximate 11 o'clock position about the axis 14a, with the piston approaching top dead center. The crankshaft is rotating clockwise, and the connecting rod/crankshaft coupling is accordingly illustrated in FIG. 2 at approximately the 1 o'clock position.

The seal plate 11A has a generally central through-hole 10a through which the connecting rod sealingly passes. The hole is located within a pivot joint 10 that can pivot with respect to the remaining portion of the seal member to accommodate the pivoting movement of the connecting rod as seen for example, by comparing the rod's respective orientation in FIGS. 1 and 2. The direction of piston movement is generally perpendicular to the axis of crankshaft rotation 14a, and the pivoting movement of the connecting rod is seen to be about a pivot axis that is generally parallel to the axis 14a.

As the connecting rod pivots within the through-hole 10a, it exerts a force against the seal plate 11A in a direction generally transverse to the direction of reciprocating piston movement. To permit a degree of transverse displacement of the seal member, the inner wall of the body 18 adjacent the seal plate 11A is preferably provided with a slideway 11B that extends generally transverse to the direction of reciprocating piston movement and is sized to accommodate the transverse displacement of the seal member induced by the reciprocating movement of the connecting rod. The peripheral end portion of the seal plate 11A extends into the slideway and is movable therein in response to lateral force exerted by the connecting rod against the seal plate. A comparison of the seal plate 11A within the slideway 11B in FIGS. 1 and 2 illustrates the accommodated movement. An oil seal 19 within the slideway substantially seals the gap between the seal member and slideway to prevent leakage between the crankcase cavity and lower cylinder chamber through the slideway.

As the piston 1 approaches bottom dead center, the air that has been increasingly compressed within the lower cylinder chamber is permitted to enter the upper cylinder chamber via a one-way valve that permits timely fluid communication between the upper and lower cylinder chambers. Accordingly, a one-way reed-type valve arrangement 6 is illustrated in FIG. 3 that permits the compressed air within the lower cylinder chamber to enter the upper cylinder chamber via an inter-chamber passageway 3 in the piston head. The valve can be opened at the appropriate time via electronic time-based control, or may be configured to open when the pressure within the lower cylinder chamber reaches a desired level.

It may be noted that compressed air within the lower cylinder chamber 18B may contain small amounts of oil. For example, oil may be thrown off from the piston/connecting rod coupling, from other lubrication points within the lower cylinder chamber or from leakage through the seal member 103. For that reason, it is preferable to include an oil shield 20 to minimize or prevent any such oil from being entering the upper cylinder chamber 18A. Oil accumulating on the surfaces of oil shield 20 remains in the lower cylinder chamber.

As the piston moves downward in the illustrated two-cycle embodiment, it carries the piston rings 2 downward past the exhaust port 8, unsealing the upper cylinder chamber's exhaust path to ambient. The incoming compressed air from the lower cylinder chamber assists in flushing the combustion products from the upper cylinder chamber and pre-charges the upper cylinder chamber with air for the next combustion process. As the piston passes bottom dead center, the valve 6 is closed, and the air in the upper cylinder chamber begins to undergo compression as the piston begins to move upward in its compression stroke, drawing a fresh charge of air into the lower cylinder chamber via intake port 16 and one-way valve 16a, as described earlier.

As the slide plate 11A slides back and forth within the slide way 11B, it is desirable to provide lubrication at the sliding interfaces. As shown in FIG. 16, a small oil-conducting channel 42, 44 can be formed in the slideway-defining body to essentially leak a small amount of oil onto the bottom surface of the slideplate as it slides within the slide way. The oil may be conducted directly from the crankcase chamber or via an oil pump and oil line, in accordance with design considerations. The same may be done for the top surface of the slide plate, or it can be lubricated by the ambient oil within the lower cylinder chamber, including the oil shed by the oil shield 20.

During the operation of the illustrated engine, it may be noted that the seal member 103 functions as an oil shield as well, substantially shielding the lower cylinder chamber (and therefore the upper cylinder chamber as well) from the oil within the crankcase chamber. By reducing the amount of unwanted oil entering the upper cylinder chamber, the seal member 103 reduces oil combustion in the upper chamber and, consequently, the resulting smoky exhaust previously associated with the burning oil of two stroke engines, while permitting the engine to include a crankcase that avoids the need to mix lubricating oil with the fuel.

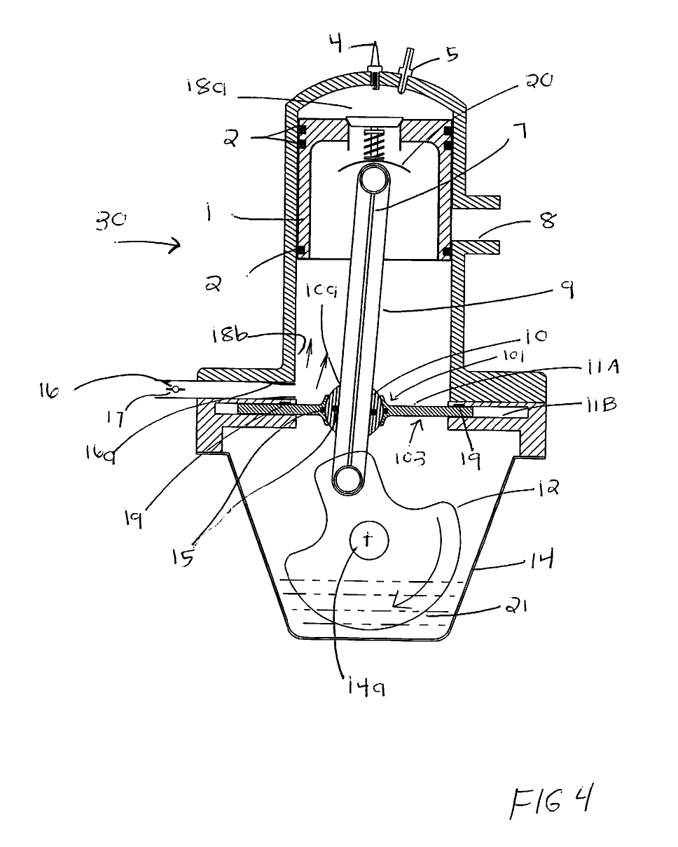

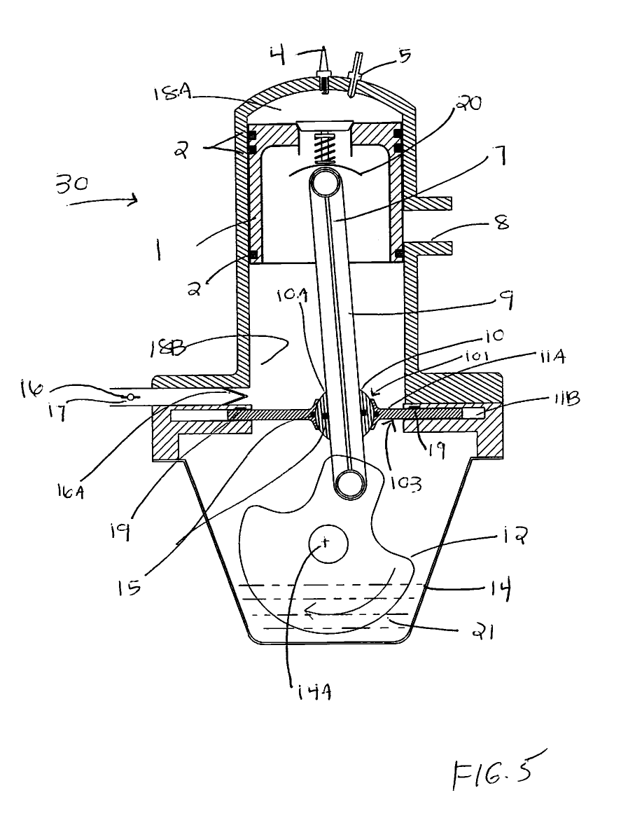

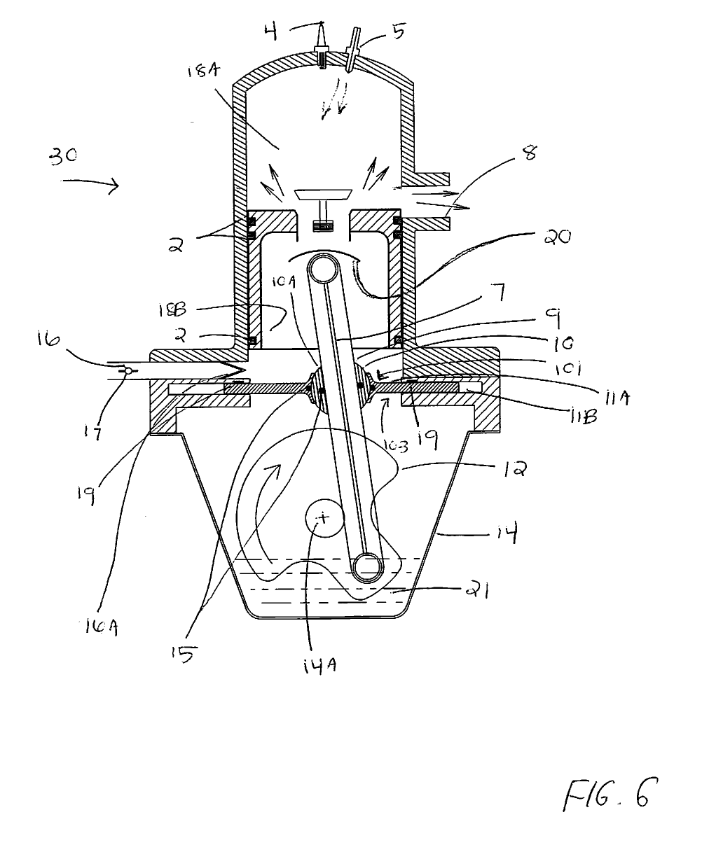

While the valve 6 permitting timely fluid communication between the upper and lower cylinder chambers illustrated in FIGS. 1-3 can, for example, be a reed valve, other valve arrangements are possible, and no limitation to any particular valve type or arrangement is intended or imposed. FIGS. 4-6, by way of example only, schematically illustrate a spring-loaded valve stem that remains closed (FIGS. 4-5) to seal the upper and lower cylinder chambers from each other until the appropriate time, whereupon it opens (FIG. 6) to permit the compressed air from the lower cylinder chamber to enter the upper cylinder chamber. The opening of the valve may be electronically, pneumatically or hydraulically controlled (as the valve illustrated in FIGS. 1-3) or may open when the force of the compressed air in the lower cylinder chamber overcomes the closure force of the spring. As illustrated in FIG. 4, the valve stem 60 includes a stem portion 62 and a valve plug portion 64 together with a spring 66 that is compressed (see FIG. 6) between the stem portion and valve body (not shown) when the valve opens. The spring returns the valve plug into sealing engagement after release of the compressed air in the lower cylinder chamber.

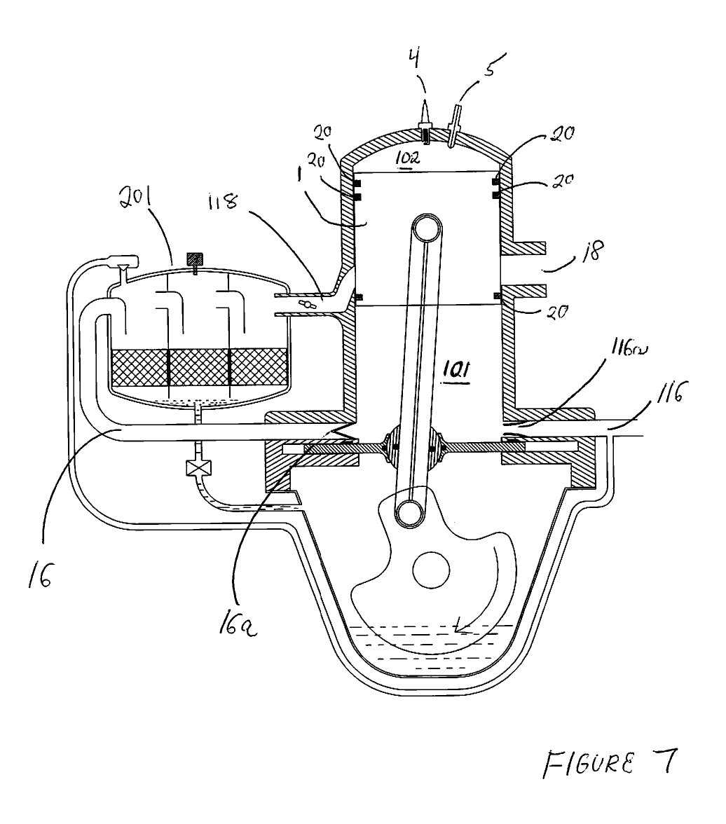

FIGS. 7-9 schematically illustrate a third embodiment of an engine constructed in accordance with the invention. In FIG. 7, the piston is approaching top dead center at the end of its compression stroke, compressing the air in upper cylinder chamber 102. Air is flowing into the lower cylinder chamber 101 from ambient via open one-way valve 116a in lower chamber intake line 116. A second one-way valve 16a in lower cylinder chamber exhaust port 16 is closed.

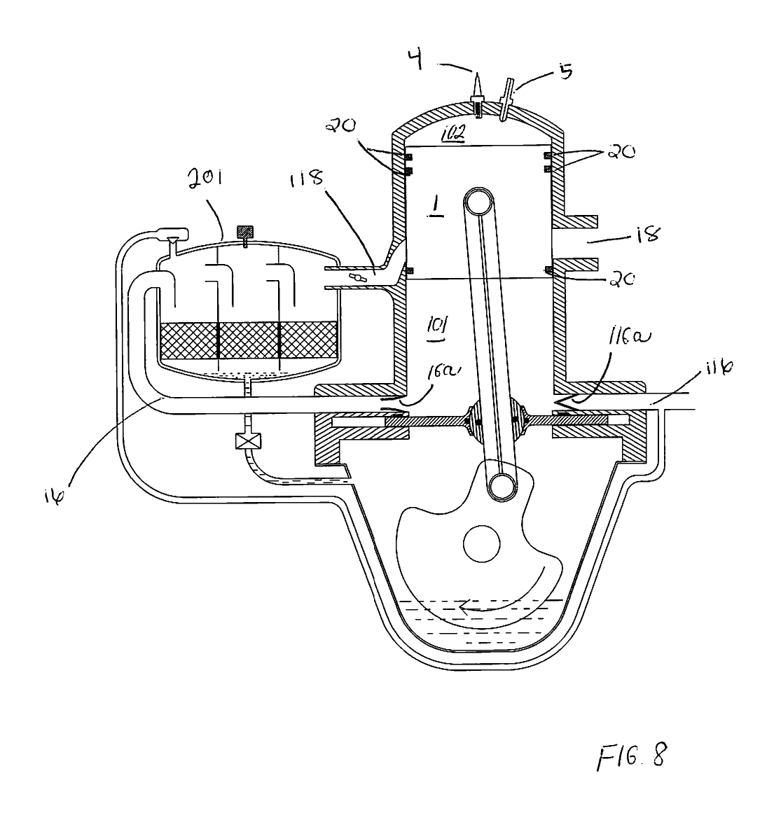

Fuel is timely injected via the fuel injector 5 into the compressed air in the upper combustion chamber 102. Both the air intake opening 16 and the exhaust port 18 are sealed from the cylinder by piston rings 2. Unless the engine is a diesel engine, a spark plug 4 fires, igniting the fuel/air mixture in the upper chamber. If the engine is a diesel engine, the fuel is ignited by timely injecting it into the upper cylinder chamber after the air in that chamber has become sufficiently heated to cause said combustion as a result of its compression by the piston as it rises towards top dead center. In either case, the ignited fuel/air mixture expands, forcing the piston 1 downward for its power stroke and compressing the air in the lower cylinder chamber 101 because the one-way valve 116a in the lower chamber intake line 116 closes, as illustrated in FIG. 8.

The second one-way valve 16a in the lower cylinder chamber exhaust port 16 opens while the piston is traveling downward in its power stroke, permitting the compressed air in the lower cylinder chamber to enter an air compression tank 201.

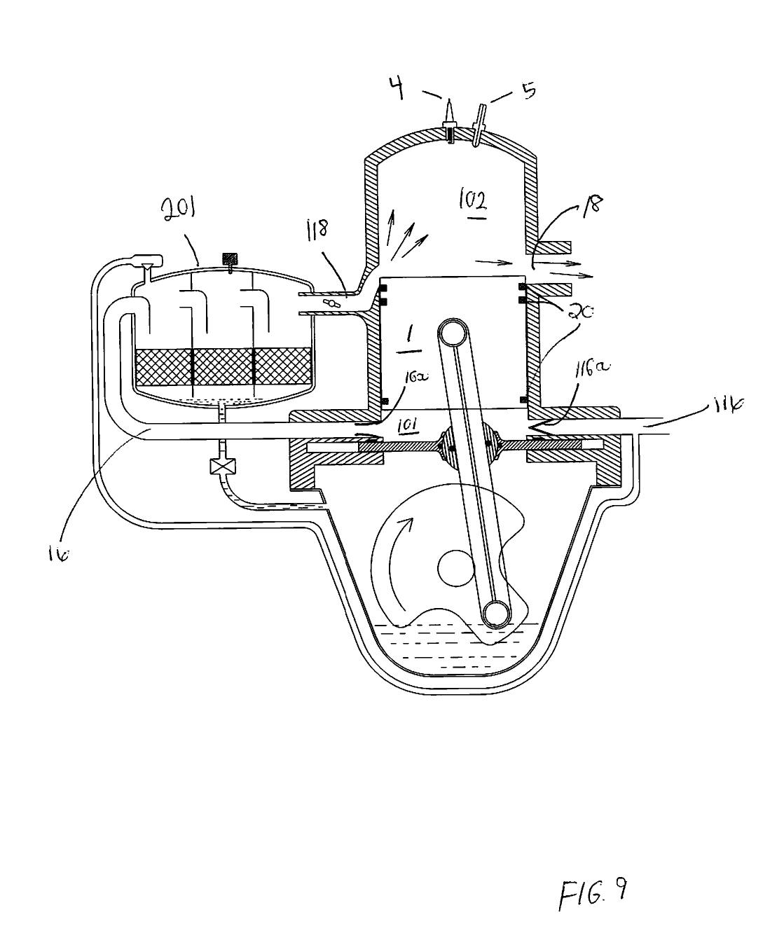

As illustrated in FIG. 9, the compressed air in the compression tank 201 is allowed to enter the upper cylinder chamber 102 when the piston 1 is near bottom dead center. The piston rings 2 have cleared the upper chamber intake port 118 and upper chamber exhaust port 18, permitting the compressed air to enter the upper cylinder chamber 102 via the upper chamber intake port 118 and push the burned air/fuel mixture out through the exhaust port 18.

As in the prior embodiments, the lower cylinder chamber is defined between the piston 1 and the seal member 103, with the pivot joint 10 responsively accommodating the reciprocal movement of the piston rod, and the seal plate 11A being responsively slidable within slideway 11B as well.

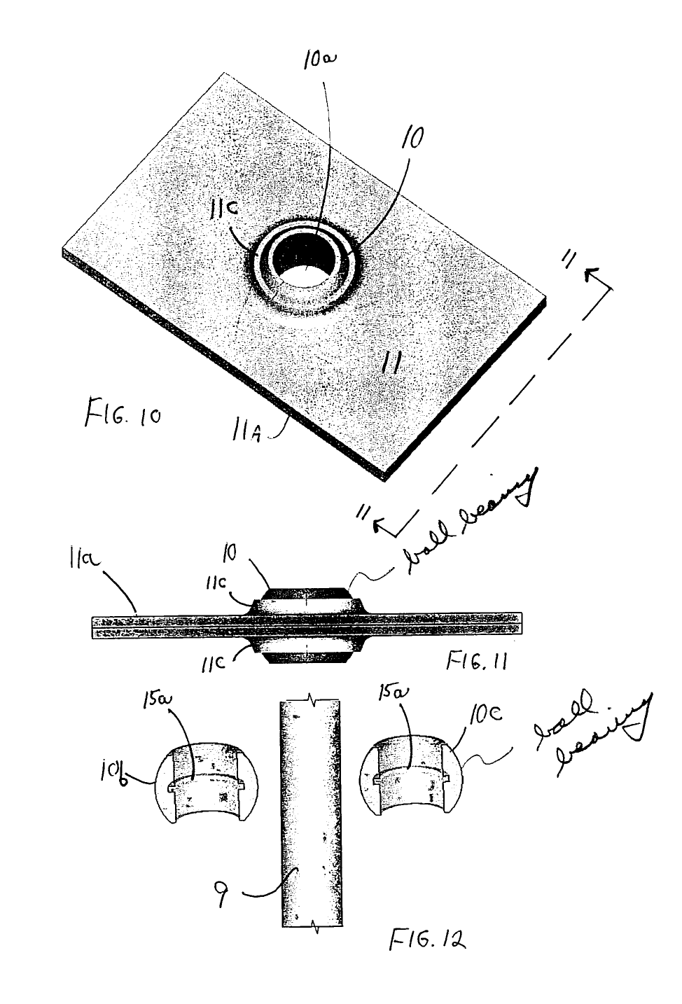

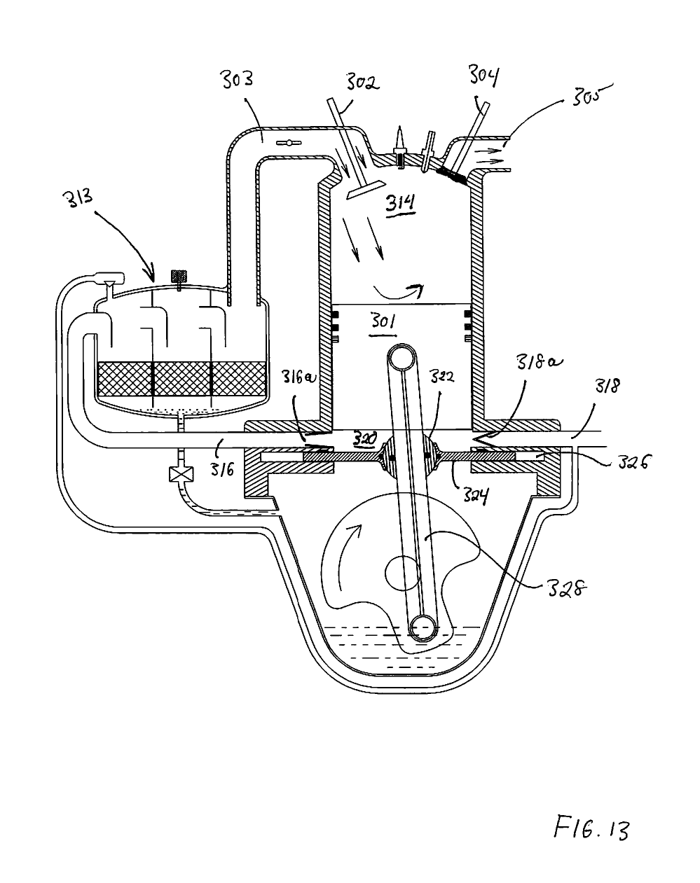

FIG. 10 is a perspective view of the seal plate 11A of FIG. 1, while FIG. 11 is a right side view of the seal plate 11A illustrated in FIG. 10 taken along line 11-11 thereof. The seal plate 11A is shown with the generally central through-hole 10a through which the connecting rod 9 passes. The pivot joint 10 is located in the throughhole and within a raised boss or collar 11C to sealingly engage the connecting rod 9 via an oil seal such as a suitable O-ring. The illustrated pivot joint pivots within the seal plate 11A in a ball-and-socket manner to accommodate the movement of the reciprocating connecting rod. As illustrated in FIG. 12, the pivot joint is preferably formed from two generally arcuate pieces 10b, 10c which respectively form one-half the ball of the ball-and socket arrangement. A circumscribing slot 15a extends around the interior wall of the pieces 10b, 10c to capture the oil seal 15. Those skilled in the art will recognize that the seal plate need not be limited to the shape illustrated in FIGS. 10-12, but can be square, round, or any other shape which provides the aforedescribed function. Moreover, the plate need not be planar, so long as it can accommodate the motion of the connecting rod. It can, for example, be wholly or partially concave or convex, or possess a generally rippled surface area so long as it can accommodate the motion of the connecting rod, with the slideway being configured accordingly to permit requisite movement of the slide plate.

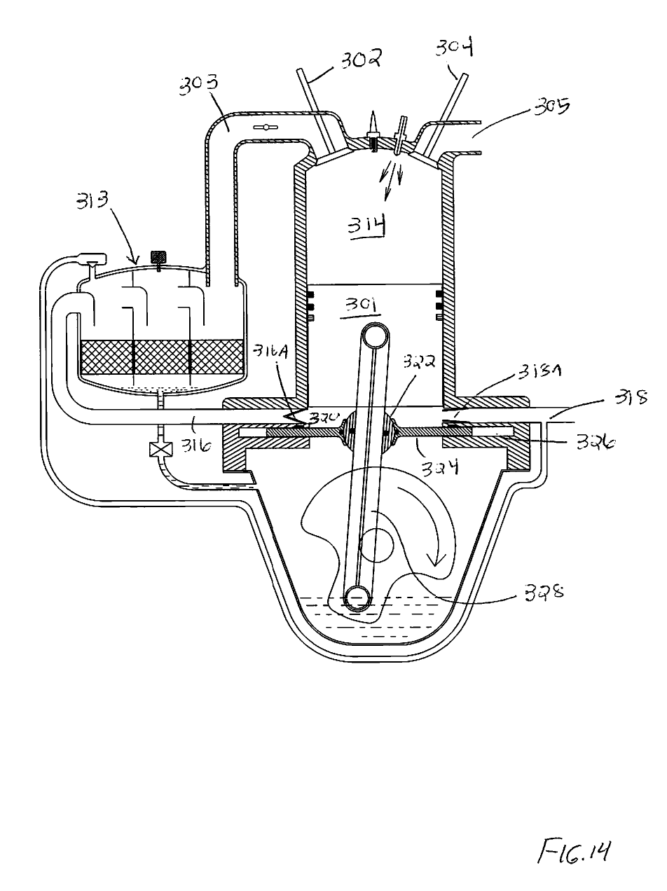

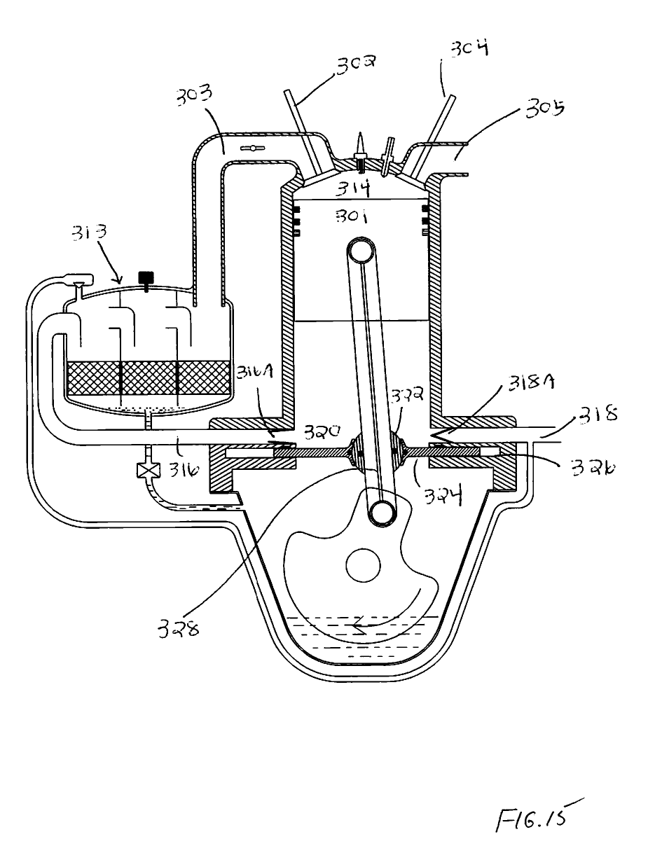

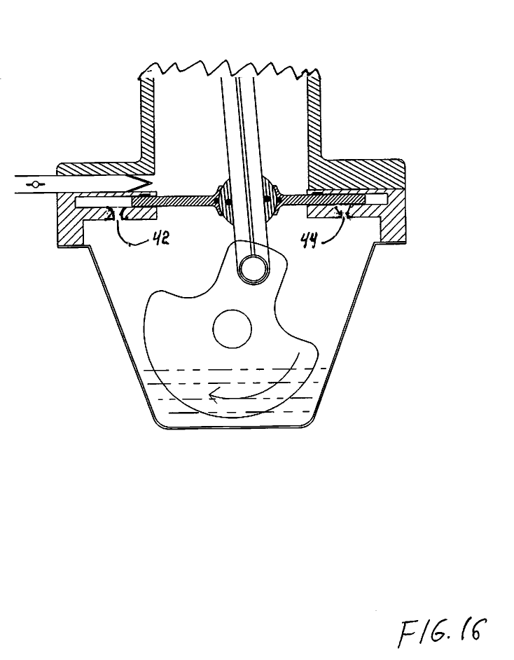

FIGS. 13-15 are respective sectional views in schematic of another engine embodiment which could be a two stroke or four stroke engine. In this case, a four stroke is described, however, although those of ordinary skill in the art will appreciate that its operation as a two-stroke engine is generally as described above but for the upper cylinder inlet and exhaust valve arrangements.

FIG. 13 illustrates the piston 301 approaching bottom dead center. Intake valve 302 is open to permit a fresh charge of air to enter the upper cylinder chamber 314 from the compression tank 313 via intake line 303. Compressed air from the lower cylinder chamber 320 has been conducted to the compressed air tank 313 through one-way valve 316a associated with lower chamber exhaust line 316. As the piston 310 rises in its compression stroke, it compresses the air/fuel mixture in the upper cylinder chamber 314, and draws a fresh charge of air into the lower cylinder chamber from ambient via one-way valve 318a associated with the lower cylinder chamber input line 318. One-way valve 318a closes so that the ignition of the gas/air mixture by the spark plug causes the mixture to expand, driving the piston downward toward bottom dead center in the power stroke and compressing the air in the lower cylinder chamber 320, which is permitted to enter the compression tank 313 by the opening of one-way valve 316a in the lower cylinder outlet line 316. The piston then travels upward once again in its exhaust stroke, pushing the combusted mixture out of the cylinder through open exhaust valve 304, drawing a fresh charge of air into the lower cylinder chamber via opened one-way valve 318a once again. The piston then repeats the four strokes, commencing with the intake stroke as described above.

Thus, the rising of the piston is accompanied by the opening of the lower cylinder chamber intake valve 318a and the closure of the lower cylinder chamber exhaust valve 316a to draw a fresh charge of air into the lower cylinder chamber, while the descent of the piston is accompanied by the closing of the lower cylinder chamber intake valve 318a and the opening of the lower cylinder chamber exhaust valve 316a to charge the compression tank 313 with compressed air from the lower cylinder chamber.

During the cycling of the piston, and as illustrated in FIGS. 13-15, the pivot joint 322 pivots within the seal plate 324, and the seal plate 324 moves transversely to the reciprocal movement of the piston 301, to accommodate the reciprocal movement of the connecting rod as the piston repeatedly draws air into the lower cylinder chamber on the upstrokes and compresses that air between the piston and seal plate on the down strokes.

It will be understood by those of ordinary skill in the art that the timing of the opening and closing the valves 302, 204, 316a and 318a can be set and/or adjusted as desirable for proper performance. In addition, the opening and closing of the lower cylinder chamber valves can be controlled to cause compression in the lower cylinder chamber during fewer than all downward movements of the piston.

The above disclosed subject matter is to be considered illustrative, and not restrictive, and the appended claims are intended to cover all such modifications, enhancements and other embodiments which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

I claim:

1. An internal combustion engine comprising:
a body having a cylinder bore extending from a top end region towards a bottom end region;
a piston mounted within the cylinder bore for reciprocating movement between top and bottom positions, and defining (a) a lower cylinder chamber between the piston and the bottom region of the cylinder bore and (b) an upper cylinder chamber between the top region of the cylinder bore and the piston;
a crankcase chamber formed adjacent the bottom end region of the cylinder bore;
a crankshaft mounted for rotation within the crankshaft chamber;
a connecting rod coupled to said piston and said crankshaft to transmit motion therebetween, so that the rotational movement of the crankshaft results in reciprocating movement of the piston;
a lower cylinder chamber seal positioned to substantially seal the lower cylinder chamber from the crankcase chamber, the seal being configured to permit the passage of the connecting rod from the crankcase chamber towards the piston and to accommodate the reciprocating movement of the connecting rod,
an intake passageway for permitting ambient air to enter the lower cylinder chamber;
an intake valve for permitting the ingress of ambient air into the lower cylinder chamber via the intake passageway and for substantially preventing the egress of air from the lower cylinder chamber via the intake passageway;
an inter-chamber passageway coupling the lower cylinder chamber and the upper cylinder chamber for fluid communication;
an inter-chamber valve arrangement for permitting fluid flow from the lower cylinder chamber to the upper cylinder chamber and for substantially preventing fluid flow from the upper cylinder chamber to the lower cylinder chamber,
said piston drawing air into the lower cylinder chamber through said intake passageway as the piston moves towards the top region of the cylinder bore and compressing the air within the lower cylinder chambers as the piston moves towards the lower cylinder chamber,
said inter-chamber valve permitting compressed air from the lower cylinder chamber to enter the upper cylinder chamber for combustion with a combustible fuel when the piston is in the vicinity of the top region of the cylinder bore;
means for igniting the compressed air to drive the piston towards the bottom region of the cylinder bore; and
an exhaust port for permitting the egress of combusted air and fuel from the upper cylinder chamber.

2. The engine of claim 1 wherein the lower cylinder chamber seal includes a seal member having a generally central connecting rod-accommodating through-hole through which the connecting rod passes, said seal member substantially sealingly engaging the connecting rod as the connecting rod undergoes reciprocal movement therethrough.

3. The engine of claim 2 wherein the seal member includes a pivot joint generally circumscribing said through-hole and pivotable with respect to at least a portion of the remaining seal member to accommodate the movement of the connecting rod along at least one axis not parallel to the direction of reciprocating movement.

4. The engine of claim 2 wherein the body includes an inner wall portion adjacent said seal member having a slide way extending generally transversely to the direction of reciprocating movement and sized to accommodate transverse displacement of the seal member induced by the reciprocating movement of the connecting rod.

6. An internal combustion engine comprising:
a body having at least one cylindrically shaped bore extending along an axis between top and bottom end regions;
a crankcase chamber;
a piston mounted within the bore for generally axially-directed reciprocal motion between a top dead center position near the top end region and a bottom dead center position near the bottom end region, the piston compressing the air between the piston and the bottom end region as it transitions from the top dead center position to the bottom dead center position;
a seal member for substantially sealing the bore from the crankcase chamber so that said compression takes place within a volume of space that is smaller than the volume of the crankcase chamber; and
a first passageway for conducting the compressed air from said bottom end region into the region between the piston and the top end region as the piston is transitioning to the top dead center position from the bottom dead center position; and
a second passageway for permitting the ingress of air into the region between the piston and the bottom end region as the piston is transitioning to the top dead center position from the bottom dead center position.
